(19) United States
(12) Patent Application Publication
(10) Pub. No.: US 2026/0362061 A1
(43) Pub. Date: Nov. 12, 2026

(54) FORCE-CANCELING SPEAKER

(71) Applicant: Tymphany HK Limited, Wanchai (HK)

(72) Inventors: Zhi LI, Taipei City (TW); YU-BING ZHAN, Taipei City (TW); JIA-JIN KUANG, Taipei City (TW)

(21) Appl. No.: 19/652,413

(22) Filed: Apr. 20, 2026

Related U.S. Application Data
(60) Provisional application No. 63/791,836, filed on Apr. 21, 2025.

(51) Int. Cl. H04R 9/06; H04R 1/02; H04R 1/24; H04R 1/28; H04R 7/12; H04R 9/02

(52) U.S. Cl. CPC H04R 9/063; H04R 1/025; H04R 1/24; H04R 1/2811; H04R 1/2834; H04R 7/12; H04R 9/025

(57) ABSTRACT

A force-canceling speaker includes a first driver, a second driver, and a housing. The first driver includes a first diaphragm that emits sound waves and vibrates parallel to a first direction. The second driver includes a second diaphragm that emits sound waves and vibrates parallel to a second direction. The housing includes a top wall, a bottom wall disposed opposite the top wall, and a side wall connecting the top wall and the bottom wall. The top wall, the bottom wall, and the side wall cooperatively define an accommodating space. The first driver and the second driver are accommodated in the accommodating space. The first direction is opposite the second direction, and the first diaphragm and the second diaphragm are arranged in directions away from each other. The housing further includes a first inclined wall and a second inclined wall connected to the top wall and the bottom wall.

### CROSS REFERENCE TO RELATED APPLICATIONS

This application claims priority of U.S. Provisional Application No. 63/791,836 filed on Apr. 21, 2025 under 35 U.S.C. § 119(e), the entire contents of which are hereby incorporated by reference.

### TECHNICAL FIELD

The present invention relates to a speaker, and more particularly to a force-canceling speaker in which two drivers are arranged back-to-back.

### BACKGROUND

Referring to FIGS. 1 and 2, FIG. 1 illustrates a conventional dual-driver speaker showing a structural arrangement of two drivers, and FIG. 2 illustrates an output gain curve of the conventional speaker over a full frequency range. As shown in FIG. 1, a conventional speaker device for vehicle audio systems integrates two low-frequency drivers E1 and E2 by disposing diaphragms E1a and E2a opposite each other, such that forces generated by the two drivers E1 and E2 cancel each other out, thereby reducing noise caused by vibration of a vehicle door.

However, in such a structural arrangement, sound waves generated by the two drivers E1 and E2 may interfere with each other. As shown in FIG. 2, a mid-frequency curve (as indicated by the solid arrow) can only extend to approximately 1.2 kHz, which results in the mid-frequency curve failing to be continuous with a high-frequency curve (as indicated by the dashed arrow), thereby causing a discontinuity in a frequency domain of sound output.

### SUMMARY

The present invention is directed to addressing deficiencies in the prior art. In particular, the present invention provides a force-canceling speaker configured to overcome problems associated with conventional designs in which two drivers are arranged with diaphragms facing each other, resulting in acoustic interference between sound waves generated by the respective drivers and causing deficiencies in the output sound frequency response.

To achieve the foregoing and other related objectives, the present invention provides a force-canceling speaker.

The force-canceling speaker comprises a first driver, a second driver, and a housing. The first driver comprises a first diaphragm, a first voice coil, and a first magnet arranged along a first axis. The first diaphragm is coupled to the first voice coil, and the first magnet interacts electromagnetically with the first voice coil such that the first diaphragm vibrates parallel to a first direction to generate sound waves. The second driver comprises a second diaphragm, a second voice coil, and a second magnet arranged along a second axis. The second diaphragm is coupled to the second voice coil, and the second magnet interacts electromagnetically with the second voice coil such that the second diaphragm vibrates parallel to a second direction to generate sound waves. The housing comprises a top wall, a bottom wall disposed opposite the top wall, and a side wall connecting the top wall and the bottom wall. The top wall, the bottom wall, and the side wall cooperatively define an accommodating space. The first driver and the second driver are accommodated in the accommodating space. The first axis is coincident with the second axis, the first direction and the second direction are opposite each other, and the first diaphragm and the second diaphragm are arranged in directions away from each other. The housing further comprises a first inclined wall and a second inclined wall connected to the top wall and the bottom wall. The first inclined wall corresponds to the first diaphragm and is inclined relative to the first axis, and the second inclined wall corresponds to the second diaphragm and is inclined relative to the second axis. The top wall has a first opening at a position corresponding to the first inclined wall, and a second opening at a position corresponding to the second inclined wall.

Optionally, the housing further includes a first mounting wall and a second mounting wall disposed opposite each other. The first mounting wall and the second mounting wall are each connected to the bottom wall and the top wall. The first driver is disposed on the first mounting wall, and the second driver is disposed on the second mounting wall. The first inclined wall is disposed opposite the first mounting wall and located on a side away from the second mounting wall, and the second inclined wall is disposed opposite the second mounting wall and located on a side away from the first mounting wall. The first driver and the second driver are positioned between the first mounting wall and the second mounting wall.

Optionally, a distance between the first inclined wall and the first mounting wall increases gradually from the bottom wall toward the top wall, and a distance between the second inclined wall and the second mounting wall increases gradually from the bottom wall toward the top wall.

Optionally, the first opening is located between the first inclined wall and the first mounting wall, and the second opening is located between the second inclined wall and the second mounting wall.

Optionally, the first mounting wall is perpendicular to the first axis, and the second mounting wall is perpendicular to the second axis.

Optionally, the force-canceling speaker further includes a passive radiator disposed on the top wall and located between the first mounting wall and the second mounting wall, wherein the passive radiator is adjacent to the accommodating space.

Optionally, the force-canceling speaker further includes a tweeter disposed between the first mounting wall and the second mounting wall. The tweeter emits sound waves in a third direction, wherein the third direction is perpendicular to the first direction and is also perpendicular to the second direction.

Optionally, the housing further includes a high-frequency chamber disposed within the accommodating space and located between the first mounting wall and the second mounting wall. The tweeter is disposed in the high-frequency chamber. The high-frequency chamber includes a third opening formed in the top wall, and the third opening is oriented in the third direction. The third opening is disposed adjacent to the passive radiator.

Optionally, the housing further includes a first resonant chamber and a second resonant chamber. The first resonant chamber is defined by the first inclined wall, the bottom wall, and the side wall. The first inclined wall comprises a first through-hole, such that the first resonant chamber is in communication with the accommodating space. The second resonant chamber is defined by the second inclined wall, the bottom wall, and the side wall. The second inclined wall comprises a second through-hole, such that the second resonant chamber is in communication with the accommodating space.

Optionally, the side wall includes a first recess and a second recess on an outer surface thereof. The first recess is located between the first resonant chamber and the top wall, and the second recess is located between the second resonant chamber and the top wall.

As described above, the force-canceling speaker of the present invention provides the following beneficial effects.

The force-canceling speaker device of the present invention arranges the first diaphragm of the first driver and the second diaphragm of the second driver to face away from each other. At the position in the housing opposite the first diaphragm, a first inclined wall is provided, and a first opening is formed at the corresponding position between the top wall and the first inclined wall. In addition, at the position opposite the second diaphragm, a second inclined wall is provided, and a second opening is formed at the corresponding position between the top wall and the second inclined wall. The sound waves generated by the first and second driver propagate in opposite directions, are respectively reflected by the first inclined wall and the second inclined wall and are subsequently emitted through the first opening and the second opening, which are located at different positions. In this manner, acoustic interference between the sound waves generated by the first driver and the sound waves generated by the second driver is mitigated, thereby avoiding deficiencies in the frequency response of the output sound. As a result, a mid-frequency range and a high-frequency range are enabled to overlap and connect with each other, yielding a complete and continuous output frequency response.

### BRIEF DESCRIPTION OF THE DRAWINGS

FIG. 1 is a schematic diagram illustrating a structural arrangement of two drivers of a conventional dual-driver speaker.

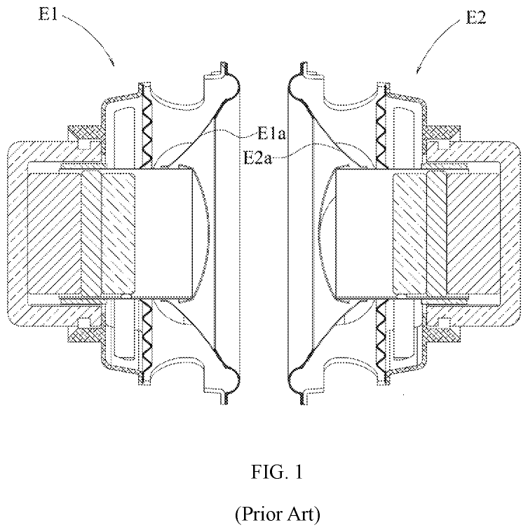

FIG. 2 is a graph illustrating a relationship between sound output gain and frequency of the speaker shown in FIG. 1.

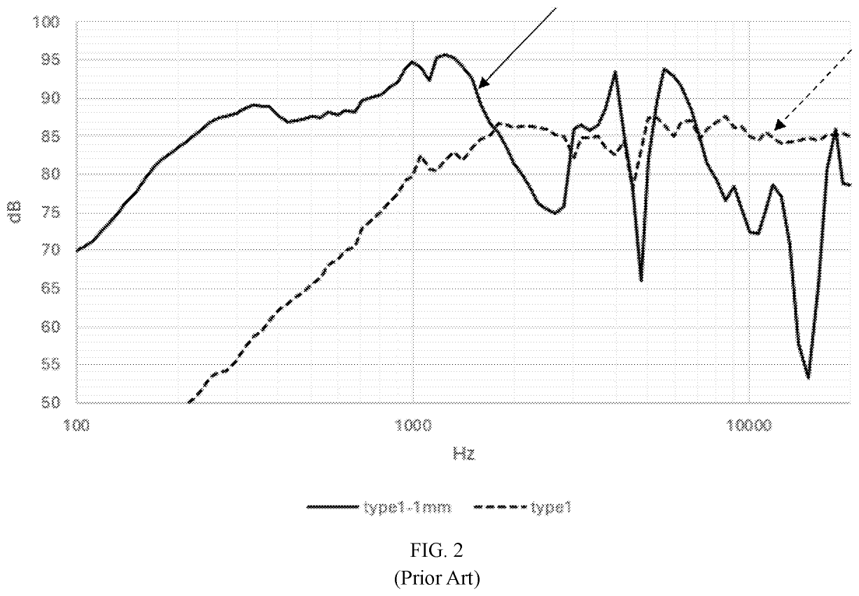

FIG. 3 is a perspective view of a force-canceling speaker according to an embodiment of the present invention.

FIG. 4 is a perspective view illustrating the force-canceling speaker of FIG. 3 with the housing removed.

FIG. 5 is a top view illustrating the force-canceling speaker of FIG. 3.

FIG. 6 is a side view illustrating the force-canceling speaker of FIG. 3.

FIG. 7 is a cross-sectional view taken along line A-A of FIG. 5.

FIG. 8 is a cross-sectional view taken along line B-B of FIG. 5.

FIG. 9 is a cross-sectional view taken along line C-C of FIG. 6.

FIG. 10 is a graph illustrating a relationship between sound output gain and frequency of the force-canceling speaker according to an embodiment of the present invention, with and without a passive radiator.

FIG. 11 is a graph illustrating a relationship between sound output gain and frequency of the force-canceling speaker according to an embodiment of the present invention, with and without a first resonant chamber and a second resonant chamber.

FIG. 12 is a graph illustrating a relationship between sound output gain and frequency in a mid-low frequency range, a high frequency range, and a full frequency range of the force-canceling speaker according to an embodiment of the present invention.

### DETAILED DESCRIPTION

In the following descriptions, specific embodiments are provided to illustrate the implementations of the present invention. Based on the invention herein, those skilled in the art can readily understand other advantages and effects of the present invention. The present invention may also be practiced or applied through various different embodiments, and the details described in the specification may be modified or altered in various ways from different perspectives and for different applications, without departing from the spirit and scope of the present invention.

For purposes of description, spatial or positional terms such as “beneath,” “below,” “under,” “lower,” “above,” “upper,” and the like may be used herein to describe the relationship between one component or features as illustrated in the accompanying drawings. It is to be understood that these spatial or positional terms are intended to encompass orientations of the device during use or operation in addition to the orientation shown in the drawings.

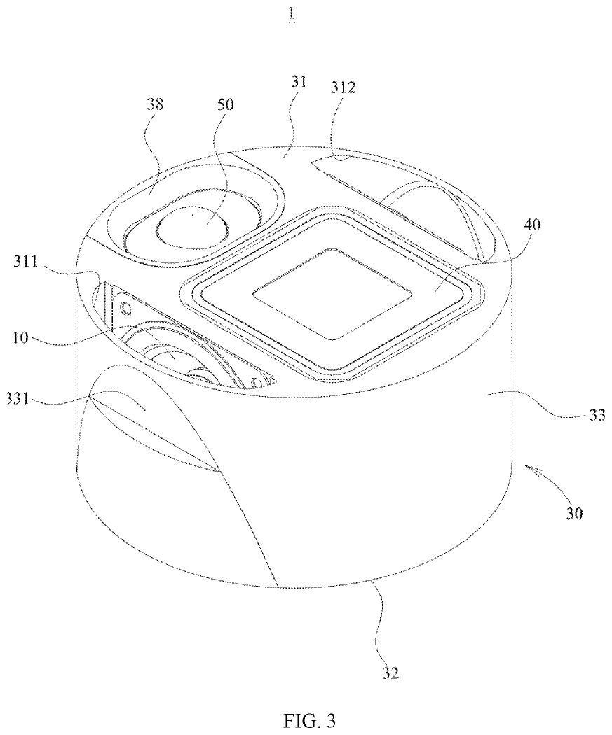

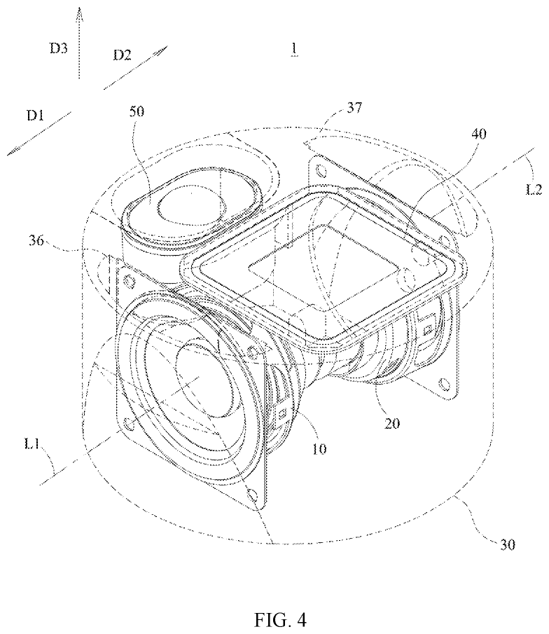

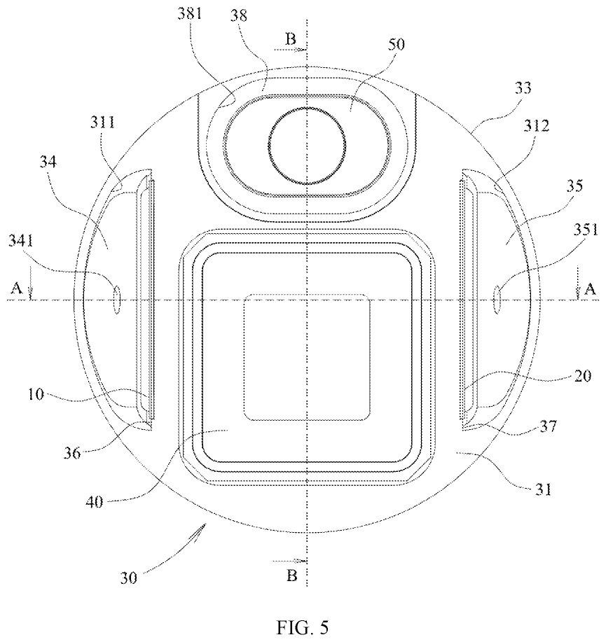

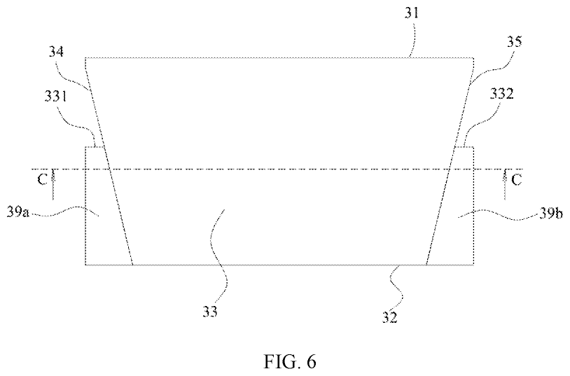

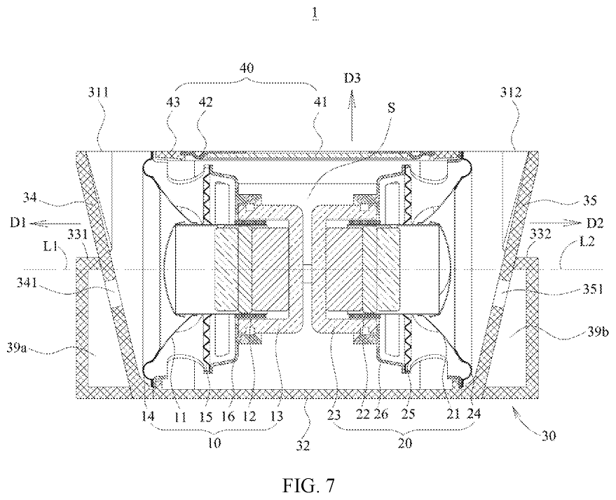

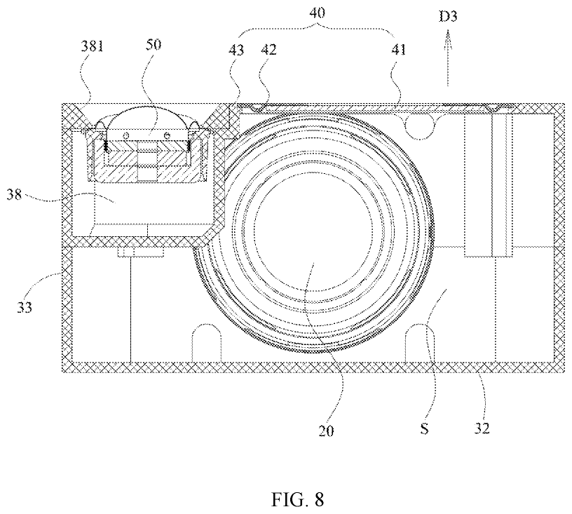

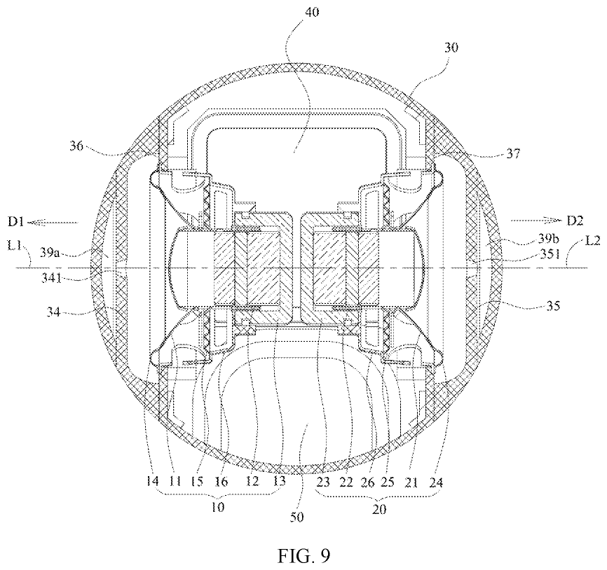

Referring to FIGS. 3-9, FIG. 3 is a perspective view of a force-canceling speaker according to an embodiment of the present invention; FIG. 4 is a perspective view illustrating the force-canceling speaker of FIG. 3 with the housing removed; FIG. 5 is a top view illustrating the force-canceling speaker of FIG. 3; FIG. 6 is a side view illustrating the force-canceling speaker of FIG. 3; FIG. 7 is a cross-sectional view taken along line A-A of FIG. 5; FIG. 8 is a cross-sectional view taken along line B-B of FIG. 5; and FIG. 9 is a cross-sectional view taken along line C-C of FIG. 6. As shown in the figures, the force-canceling speaker 1 according to the present embodiment comprises a first driver 10, a second driver 20, and a housing 30. The first driver 10 and the second driver 20 are arranged in a back-to-back manner within the housing 30.

The first driver 10 comprises a first diaphragm 11, a first voice coil 12, and a first magnet 13 arranged along a first axis L1. The first diaphragm 11 is coupled to the first voice coil 12, and the first magnet 13 interacts electromagnetically with the first voice coil 12 such that the first diaphragm 11 vibrates parallel to a first direction D1 to generate sound waves. The first driver 10 further comprises a first surround 14, a first spider 15, and a first basket 16. The first diaphragm 11 is supported on the first basket 16 through the first surround 14 and the first spider 15.

The second driver 20 comprises a second diaphragm 21, a second voice coil 22, and a second magnet 23 arranged along a second axis L2. The second diaphragm 21 is coupled to the second voice coil 22, and the second magnet 23 interacts electromagnetically with the second voice coil 22 such that the second diaphragm 21 vibrates parallel to a second direction D2 to generate sound waves. The second driver 20 further comprises a second surround 24, a second spider 25, and a second basket 26. The second diaphragm 21 is supported on the second basket 26 through the second surround 24 and the second spider 25.

The housing 30 comprises a top wall 31, a bottom wall 32 disposed opposite the top wall 31, and a side wall 33 connecting the top wall 31 and the bottom wall 32. In the present embodiment, the side wall 33 is a circular side wall such that the top wall 31 and the bottom wall 32, in cooperation with the side wall 33, are also circular. The top wall 31 and the bottom wall 32 are parallel to each other and are spaced apart by a predetermined distance. However, the present invention is not limited thereto, and the side wall may alternatively be a polygonal side wall formed by a plurality of planar wall segments connected to one another. The top wall 31, the bottom wall 32, and the side wall 33 cooperatively define an accommodating space S. The first driver 10 and the second driver 20 are accommodated in the accommodating space S.

The housing 30 further comprises a first inclined wall 34, a second inclined wall 35, a first mounting wall 36, and a second mounting wall 37, each connected to the top wall 31 and the bottom wall 32. The first mounting wall 36 and the second mounting wall 37 are parallel to each other and are disposed opposite each other. The first mounting wall 36 is perpendicular to the first axis L1, and the second mounting wall 37 is perpendicular to the second axis L2. The first basket 16 of the first driver 10 is fixed to the first mounting wall 36, and the second basket 26 of the second driver 20 is fixed to the second mounting wall 37. The first inclined wall 34 is disposed opposite the first mounting wall 36 and is located on a side away from the second mounting wall 37, and the second inclined wall 35 is disposed opposite the second mounting wall 37 and is located on a side away from the first mounting wall 36. The first driver 10 and the second driver 20 are positioned between the first mounting wall 36 and the second mounting wall 37. The first inclined wall 34 corresponds to the first diaphragm 11 and is inclined relative to the first axis L1, and an angle between the first inclined wall 34 and the first axis L1 is between 55° and 75°. The second inclined wall 35 corresponds to the second diaphragm 21 and is inclined relative to the second axis L2, and an angle between the second inclined wall 35 and the second axis L2 is between 55° and 75°. The distance between the first inclined wall 34 and the first mounting wall 36 increases gradually from the bottom wall 32 toward the top wall 31, and the distance between the second inclined wall 35 and the second mounting wall 37 increases gradually from the bottom wall 32 toward the top wall 31.

The top wall 31 comprises a first opening 311 at a position corresponding to the first inclined wall 34 and comprises a second opening 312 at a position corresponding to the second inclined wall 35. The first opening 311 is located between the first inclined wall 34 and the first mounting wall 36, and the second opening 312 is located between the second inclined wall 35 and the second mounting wall 37.

Through the arrangement in which the first driver 10 is disposed on the first mounting wall 36 and the second driver is disposed on the second mounting wall 37, the first axis L1 of the first driver 10 is coincident with the second axis L2 of the second driver 20. The first direction D1 and the second direction D2 are opposite each other, and the first diaphragm 11 and the second diaphragm 21 are arranged in directions away from each other. In this manner, the first driver 10 and the second driver 20 form a back-to-back configuration. Sound waves generated by the first diaphragm 11 propagate in the first direction D1 and then reach the first inclined wall 34. The first inclined wall 34 reflects the sound waves such that the sound waves are emitted through the first opening 311. Sound waves generated by the second diaphragm 21 propagate in the second direction D2 and then reach the second inclined wall 35. The second inclined wall 35 reflects the sound waves such that the sound waves are emitted through the second opening 312.

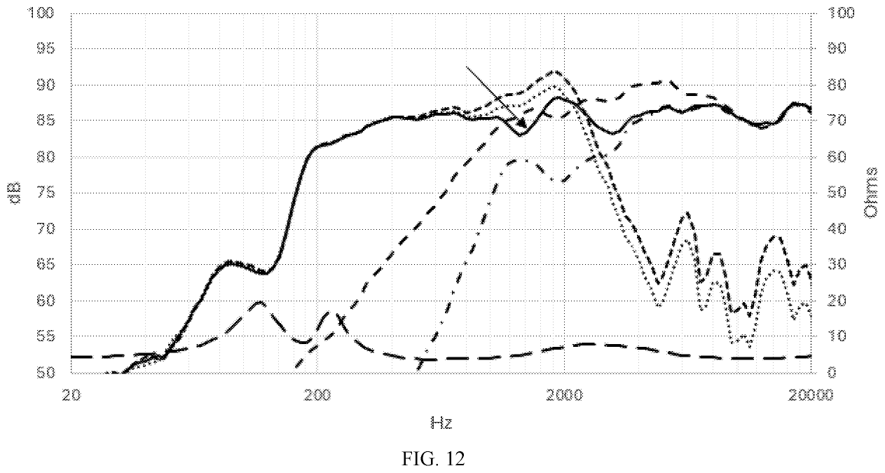

The space between the first inclined wall 34 and the first mounting wall 36 forms a channel for propagating sound waves generated by the first driver 10. Likewise, the space between the second inclined wall 35 and the second mounting wall 37 forms a channel for propagating the sound waves generated by the second driver 20. In this manner, the sound waves generated by the first driver 10 and the sound waves generated by the second driver 20 are emitted from the housing 30 through different channels located at opposite sides of the housing 30, and the sound waves are then combined with each other outside the housing 30 to form a sound field. As a result, a continuous full-range frequency response is achieved, in which a mid-frequency range and a high-frequency range overlap coherently, as illustrated by the arrow in FIG. 12. This avoids the problem encountered in conventional designs having two drivers in which sound waves are emitted through a single common channel and interfere with each other inside the housing, thereby causing discontinuities in the output frequency response.

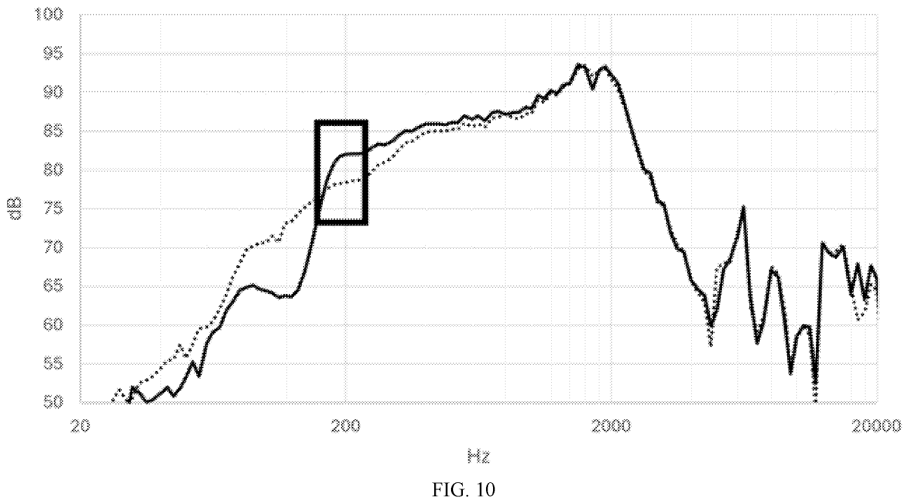

The force-canceling speaker 1 of the present invention further includes a passive radiator 40 disposed on the top wall 31 of the housing 30 and located between the first mounting wall 36 and the second mounting wall 37. The passive radiator 40 is adjacent to the accommodating space S. The passive radiator 40 comprises a third diaphragm 41, a third surround 42, and a third basket 43. The passive radiator 40 does not include a voice coil or a magnet. The third diaphragm 41 is supported on the third basket 43 through the third surround 42. The third diaphragm 41 of the passive radiator 40 is driven into vibration by pressure variations generated within the accommodating space S when the first diaphragm 11 and the second diaphragm 21 vibrate, thereby causing the third diaphragm 41 to vibrate and in turn drive the air outside the housing 30 to generate sound waves. As indicated by the box in FIG. 10, the provision of the passive radiator 40 enables a 3.5 dB increase in sound-wave gain at 200 Hz.

The housing 30 further includes a high-frequency chamber 38. The high-frequency chamber 38 is disposed within the accommodating space S and is located between the first mounting wall 36 and the second mounting wall 37. The high-frequency chamber 38 comprises a third opening 381 formed in the top wall 31, and the third opening 381 is oriented in the third direction D3. The third opening 381 is disposed adjacent to the passive radiator 40. The force-canceling speaker 1 of the present invention further includes a tweeter 50. The tweeter 50 is disposed in the high-frequency chamber 38 and emits sound waves in the third direction D3. The third direction D3 is perpendicular to the first direction D1 and is also perpendicular to the second direction D2.

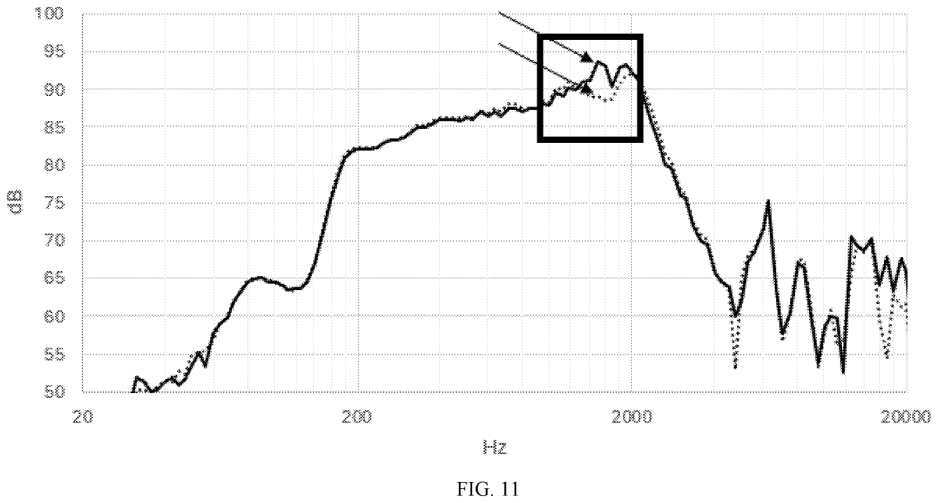

The housing 30 further comprises a first resonant chamber 39a and a second resonant chamber 39b. The first resonant chamber 39a is defined by the first inclined wall 34, the bottom wall 32, and the side wall 33. The first inclined wall 34 comprises a first through-hole 341, such that the first resonant chamber 39a is in communication with the accommodating space S (i.e., a sound-wave channel) defined by the first inclined wall 34 and the first mounting wall 36. The first resonant chamber 39a is located on a side of the first inclined wall 34 opposite the first mounting wall 36. The second resonant chamber 39b is defined by the second inclined wall 35, the bottom wall 32, and the side wall 33. The second inclined wall 35 comprises a second through-hole 351, such that the second resonant chamber 39b is in communication with the accommodating space S (i.e., a sound-wave channel) defined by the second inclined wall 35 and the second mounting wall 37. The Helmholtz resonance generated by the first resonant chamber 39a and the second resonant chamber 39b mitigates peaks in sound-wave gain, as indicated by the box in FIG. 11, thereby allowing the gain to extend smoothly up to 2.2 kHz.

The side wall 33 further comprises a first recess 331 and a second recess 332 on an outer surface thereof. The first recess 331 is located between the first resonant chamber 39a and the top wall 31, and the second recess 332 is located between the second resonant chamber 39b and the top wall 31. The first recess 331 and the second recess 332 reduce the thickness of the side wall 33 to achieve weight reduction, and the first recess 331 and the second recess 332 also facilitate user gripping.

The force-canceling speaker of the present invention arranges the first diaphragm of the first driver and the second diaphragm of the second driver in directions away from each other. A first inclined wall is provided at a position of the housing corresponding to the first diaphragm, and a first opening is formed in the top wall at a position corresponding to the first inclined wall. Likewise, a second inclined wall is provided at a position of the housing corresponding to the second diaphragm, and a second opening is formed in the top wall at a position corresponding to the second inclined wall. Sound waves generated by the first driver and sound waves generated by the second driver propagate in opposite directions and are respectively reflected by the first inclined wall and the second inclined wall, and are then emitted through the first opening and the second opening, which are located at different positions. In this manner, sound waves generated by the respective drivers avoid interfering with each other within the housing, thereby preventing defects in the frequency response of the output sound. As a result, the mid-frequency range and the high-frequency range overlap and connect with each other, yielding a complete and continuous full-range sound-wave output.

The foregoing embodiments are merely illustrative for explaining the principles and advantages of the present invention, and are not intended to limit the present invention. Various modifications and alterations to the above-described embodiments can be made by those skilled in the art without departing from the spirit and scope of the present invention. Accordingly, all equivalent modifications and alterations made by those of ordinary skill in the relevant art, without departing from the spirit and technical concepts disclosed herein, shall fall within the scope of the present invention.

What is claimed is:

1. A force-canceling speaker comprising:
a first driver comprising:
a first voice coil;
a first diaphragm coupled to the first voice coil; and
a first magnet arranged along a first axis, wherein the first magnet electromagnetically interacts with the first voice coil such that the first diaphragm vibrates parallel to a first direction to generate sound waves;
a second driver comprising:
a second voice coil;
a second diaphragm coupled to the second voice coil; and
a second magnet arranged along a second axis, wherein the second magnet electromagnetically interacts with the second voice coil such that the second diaphragm vibrates parallel to a second direction to generate sound waves; and
a housing comprising:
a top wall;
a bottom wall disposed opposite the top wall;
a side wall connecting the top wall and the bottom wall, wherein the top wall, the bottom wall, and the side wall define an accommodating space in which the first driver and the second driver are accommodated; and
a first inclined wall and a second inclined wall connected to the top wall and the bottom wall, wherein the first inclined wall corresponds to the first diaphragm and is inclined relative to the first axis and wherein the second inclined wall corresponds to the second diaphragm and is inclined relative to the second axis,
wherein the first axis is coincident with the second axis, the first direction and the second direction are opposite each other, and the first diaphragm and the second diaphragm are arranged in directions facing away from each other, and
wherein the top wall comprises a first opening at a position corresponding to the first inclined wall and a second opening at a position corresponding to the second inclined wall.

2. The force-canceling speaker of claim 1, wherein the housing further comprises a first mounting wall and a second mounting wall disposed opposite each other,
wherein the first mounting wall and the second mounting wall are each connected to the bottom wall and the top wall, the first driver is disposed on the first mounting wall, and the second driver is disposed on the second mounting wall,
wherein the first inclined wall is disposed opposite the first mounting wall and is located on a side away from the second mounting wall,
wherein the second inclined wall is disposed opposite the second mounting wall and is located on a side away from the first mounting wall, and
wherein the first driver and the second driver are positioned between the first mounting wall and the second mounting wall.

3. The force-canceling speaker of claim 2, wherein a distance between the first inclined wall and the first mounting wall increases gradually from the bottom wall toward the top wall, and a distance between the second inclined wall and the second mounting wall increases gradually from the bottom wall toward the top wall.

4. The force-canceling speaker of claim 2, wherein the first opening is located between the first inclined wall and the first mounting wall, and the second opening is located between the second inclined wall and the second mounting wall.

5. The force-canceling speaker of claim 2, wherein the first mounting wall is perpendicular to the first axis, and the second mounting wall is perpendicular to the second axis.

6. The force-canceling speaker of claim 2, further comprising a passive radiator disposed on the top wall and located between the first mounting wall and the second mounting wall, wherein the passive radiator is adjacent to the accommodating space.

7. The force-canceling speaker of claim 6, further comprising a tweeter disposed between the first mounting wall and the second mounting wall, wherein the tweeter is configured to emit sound waves in a third direction, the third direction being perpendicular to the first direction and the second direction.

8. The force-canceling speaker of claim 7, wherein the housing further comprises a high-frequency chamber disposed within the accommodating space and located between the first mounting wall and the second mounting wall,
wherein the tweeter is disposed in the high-frequency chamber, and
wherein the high-frequency chamber comprises a third opening at the top wall, the third opening being oriented in the third direction and disposed adjacent to the passive radiator.

9. The force-canceling speaker of claim 1, wherein the housing further comprises a first resonant chamber and a second resonant chamber,
wherein the first resonant chamber is defined by the first inclined wall, the bottom wall, and the side wall,
wherein the first inclined wall comprises a first through-hole such that the first resonant chamber is in communication with the accommodating space,
wherein the second resonant chamber is defined by the second inclined wall, the bottom wall, and the side wall, and
wherein the second inclined wall comprises a second through-hole such that the second resonant chamber is in communication with the accommodating space.

10. The force-canceling speaker of claim 9, wherein the side wall comprises a first recess and a second recess on an outer surface thereof,
wherein the first recess is located between the first resonant chamber and the top wall, and
wherein the second recess is located between the second resonant chamber and the top wall.
